(19) United States
(12) Patent Application Publication
(10) Pub. No.: US 2018/0218677 A1
(43) Pub. Date: Aug. 2, 2018

(54) PIXEL DRIVING CIRCUIT, DISPLAY APPARATUS AND DRIVING METHOD THEREOF

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Haigang QING, Beijing (CN); Xiaojing QI, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu, Sichuan (CN)

(21) Appl. No.: 15/508,879

(22) PCT Filed: Aug. 11, 2016
(86) PCT No.: PCT/CN2016/094639

§ 371 Date: Mar. 3, 2017

(30) Foreign Application Priority Data
Oct. 22, 2015 (CN) 201510694946.7

(51) Int. Cl. G09G 3/3233

(52) U.S. Cl. CPC G09G 3/3233; G09G 2320/0233; G09G 2300/0852; G09G 2300/0819

(57) ABSTRACT

A pixel driving circuit includes: a driving transistor having a threshold voltage; a light-emitting element electrically coupled with the driving transistor; a storage capacitor configured to store a display data voltage from data input; and a threshold capacitor configured to store the threshold voltage; wherein the pixel driving circuit is configured to compensate for a variation in the threshold voltage based on the threshold voltage stored in the threshold capacitor prior to the display data voltage being written to the storage capacitor to thereby improve a luminance uniformity of the light-emitting element.

### CROSS-REFERENCE TO RELATED APPLICATION

The present application claims priority to Chinese Patent Application No. 201510694946.7 filed on Oct. 22, 2015, the disclosure of which is hereby incorporated by reference in its entirety.

### TECHNICAL FIELD

The present disclosure relates generally to the field of display technologies, and more specifically to a pixel driving circuit, a display apparatus, and a driving method thereof.

### BACKGROUND

Consumers have an increasingly higher demands for better display effects of display apparatuses. To meet the demands, manufacturers have developed many new types of display apparatuses, such as organic light-emitting diode (OLED) display apparatuses. Depending on the different driving modes, OLED display apparatuses can be active-matrix OLED (AMOLED) display apparatuses, or passive-matrix OLED (PMOLED) display apparatuses.

An AMOLED display apparatus includes a driving transistor array configured to drive the OLEDs to emit light. In the driving transistor array, individual driving transistors correspond to individual OLEDs, to realize the autonomous light-emitting. Typically, driving thin-film transistors (TFTs) are adopted to provide drive currents to the OLEDs at a saturation state.

### SUMMARY

The inventors of the present disclosure have recognized that there is unevenness during fabrication of the driving transistor array, resulting in different threshold voltages in different driving transistors. This can occur for both low-temperature polycrystalline silicon (LTPS) technologies, and oxide technologies.

As a result, if two different driving transistors with different threshold voltages are input with a same data voltage, different driving currents are generated in the two driving transistors at their respective saturations, causing the OLEDs corresponding to, and driven by, the two driving transistors to emit lights with different luminescence, ultimately affecting the uniformity of the OLED display apparatus.

Moreover, during the lifetime of the OLED display apparatus, more and more un-recombined carriers can be accumulated at interfaces in the light-emitting layer. These carriers can build an internal electric field, resulting in an increase in the threshold voltage of the OLED, and correspondingly a decrease in the luminance.

A pixel driving circuit, a display apparatus, and a driving method thereof are provided to solve or alleviate at least some problems of uneven luminescence in the OLED display apparatus resulting from different threshold voltages in different driving transistors.

In an aspect, a pixel driving circuit is provided, including: a driving transistor having a threshold voltage; a light-emitting element electrically coupled with the driving transistor; a storage capacitor configured to store a display data voltage from data input; and a threshold capacitor configured to store the threshold voltage; wherein the pixel driving circuit is configured to compensate for a variation in the threshold voltage based on the threshold voltage stored in the threshold capacitor prior to the display data voltage being written to the storage capacitor to thereby improve a luminance uniformity of the light-emitting element.

In some embodiments, the threshold capacitor is configured to obtain the threshold voltage based on a cut-off state of the driving transistor.

In some embodiments, the storage capacitor has a first end electrically coupled with a first end of the threshold capacitor, and a second end electrically coupled with a high-level power supply terminal.

In some embodiments, the threshold capacitor has a second end electrically coupled with a gate electrode of the driving transistor, and is configured to obtain the threshold voltage by discharging the first end of the threshold capacitor until the cut-off state of the driving transistor.

In some embodiments, the pixel driving circuit is configured to compensate for a variation in the threshold voltage by generating a driving current for the light-emitting element independent of the threshold voltage based on the threshold voltage obtained by the threshold capacitor.

In some embodiments, the pixel driving circuit further includes: a first transistor, a second transistor, and a third transistor, wherein the light-emitting element comprises an organic light-emitting diode (OLED); a gate electrode of the first transistor is coupled with a light emission control line; a first electrode of the first transistor is coupled with a high-level power supply terminal; a second electrode of the first transistor is coupled with a first electrode of the second transistor and a first end of the driving transistor; a second end of the driving transistor is coupled with an anode of the OLED; and a cathode of the OLED is coupled with a low-level ground terminal.

In some embodiments, a first scan line is coupled with a gate electrode of the second transistor and a gate electrode of the third transistor; a signal terminal of a signal input circuit is electrically coupled with a second electrode of the second transistor, the first end of the storage capacitor, and the first end of the threshold capacitor; the second end of the threshold capacitor is coupled with a first electrode of the third transistor; and a second electrode of the third transistor is coupled with one of the anode or the cathode of the OLED.

In some embodiments, the signal input circuit further comprises a fourth transistor, wherein: a gate electrode of the fourth transistor is coupled with a second scan line; a first electrode of the fourth transistor is coupled with a data line; and a second electrode of the fourth transistor is the signal terminal of the signal input circuit.

In some embodiments, the pixel driving circuit further includes a fifth transistor configured to short the anode and the cathode of the OLED to thereby reset the OLED.

In some embodiments, a gate electrode of the fifth transistor is coupled with the first scan line; a first electrode of the fifth transistor is coupled with the anode of the OLED; and a second electrode of the fifth transistor is coupled with the cathode of the OLED.

In some embodiments, the second electrode of the third transistor is coupled with the low-level ground terminal.

In another aspect, a display apparatus is provided, including a plurality of pixel driving circuits described above.

In another aspect, a method is provided for driving a display apparatus comprising a plurality of pixels each having at least one light-emitting element, the method including: for each pixel, storing a threshold voltage of a driving transistor in a threshold voltage capacitor; for each pixel, writing a display data voltage to a storage capacitor; and displaying an image over the plurality of pixels according to the plurality of display data voltages and compensating for a variation in the plurality of threshold voltages based on the stored threshold voltage to thereby improve a luminance uniformity of the displayed image.

In some embodiments, the method further includes, prior to the storing the threshold voltage, obtaining the threshold voltage based on a cut-off state of the driving transistor.

In some embodiments, the method further includes: a reset stage including resetting the storage capacitor and the threshold voltage capacitor; a threshold compensation stage including the obtaining the threshold voltage by discharging the threshold capacitor until the cut-off state of the driving transistor; a display data writing stage including the writing the display data voltage; and a display stage including the displaying the image.

In some embodiments, the method further includes shorting an anode and a cathode of the light-emitting element to thereby reduce un-recombined carriers in the light-emitting element.

In some embodiments, the method further includes a first buffer stage between the threshold compensation stage and the display data writing stage to prevent noise resulting from a plurality of control signals being simultaneously switched on or off.

In some embodiments, the method further includes a second buffer stage between the display data writing stage and the display stage to prevent noise resulting from the plurality of control signals being simultaneously switched on or off.

In some embodiments, the obtaining the threshold voltage comprises discharging the threshold voltage capacitor from a high-level power supply voltage until the pixel driving transistor turns off.

In some embodiments, the displaying the image comprises driving the light-emitting element with a saturation current of the pixel driving transistor independent of the threshold voltage of the pixel driving transistor. At least some of the embodiments disclosed herein have one or more of the following advantages.

In the pixel driving circuit as described above, by coupling with the gate electrode of the first transistor T1, the light emission control line EM₍ₙ₎ turns on and/or off the first transistor T1; by respectively coupling with the gate electrode of the second transistor T2 and the gate electrode of the third transistor T3, the first scan line G₍ₙ₋₁₎ turns on and/or off the second transistor T2 and the third transistor T3.

As such, when the signal input circuit provides the display data voltage V_{data}, the voltage across the storage capacitor Cₛₜ is equal to the difference between the power supply voltage ELVDD and the display data voltage V_{data}, the voltage across the threshold capacitor C_{Vth} is equal to the threshold voltage Vₜₕ of the driving transistor DTFT, and the voltage between the gate electrode and the first electrode of the driving transistor DTFT V_{DTFT} is:

V_{DTFT}=ELVDD−V_{data}+|Vₜₕ|. (I)

In addition, because the power supply voltage ELVDD causes the driving transistor DTFT to work in saturation and generate a driving current I_{oled};

I_{oled}=k(V_{DTFT}−Vₜₕ|)² (II)

Combining Formula (I) with Formula (II), it can be obtained:

I_{oled}=k(ELVDD−V_{data}+|Vₜₕ|−|Vₜₕ|)²=k(ELVDD−V_{data})², (III)

where in formula (III), k is a constant.

Based on the above formulas, the driving current I_{oled} correlates with the power supply voltage ELVDD and the display data voltage V_{data}, but not with the threshold voltage Vₜₕ. Accordingly, if a same data voltage is applied to a plurality of driving transistors DTFT having different threshold voltages Vₜₕ, the driving currents generated by these driving transistors DTFT while at saturation are the same.

As such, the corresponding OLEDs driven by these driving transistors DTFT can emit light of a same luminescence. The uneven luminescence in OLED displays resulting from the use of driving transistors DTFT having different threshold voltages Vₜₕ can thus be reduced or eliminated.

In another aspect, a pixel driving circuit is provided, including: a driving transistor having a threshold voltage; a light-emitting element electrically coupled with the driving transistor; a storage capacitor configured to store a display data voltage from data input; and a threshold capacitor configured to store the threshold voltage; a first transistor; a second transistor; and a third transistor.

Wherein: the light-emitting element comprises an organic light-emitting diode (OLED); a gate electrode of the first transistor is coupled with a light emission control line; a first electrode of the first transistor is coupled with a high-level power supply terminal; a second electrode of the first transistor is coupled with a first electrode of the second transistor and a first end of the driving transistor; a second end of the driving transistor is coupled with an anode of the OLED; and a cathode of the OLED is coupled with a low-level ground terminal.

In another aspect, a pixel driving circuit is provided, including: a driving transistor having a threshold voltage; a light-emitting element electrically coupled with the driving transistor; a storage capacitor; a threshold capacitor; a first transistor; a second transistor; a third transistor.

Wherein: the light-emitting element comprises an organic light-emitting diode (OLED); a gate electrode of the first transistor is coupled with a light emission control line; a first electrode of the first transistor is coupled with a high-level power supply terminal; a second electrode of the first transistor is coupled with a first electrode of the second transistor and a first end of the driving transistor; a second end of the driving transistor is coupled with an anode of the OLED.

The third transistor has a first electrode coupled with the threshold capacitor, and a second electrode coupled with the anode of the OLED. A cathode of the OLED is coupled with a low-level ground terminal.

A first scan line can be provided for the pixel driving circuit and is coupled with a gate electrode of the second transistor and a gate electrode of the third transistor. A signal terminal of a signal input circuit is electrically coupled with a second electrode of the second transistor, the first end of the storage capacitor, and the first end of the threshold capacitor. The second end of the threshold capacitor is coupled with a first electrode of the third transistor; and a second electrode of the third transistor is coupled with the anode of the OLED.

The signal input circuit further comprises a fourth transistor, wherein: a gate electrode of the fourth transistor is coupled with a second scan line; a first electrode of the fourth transistor is coupled with a data line; and a second electrode of the fourth transistor is the signal terminal of the signal input circuit.

In another aspect, a pixel driving circuit is provided, including: a driving transistor having a threshold voltage; a light-emitting element electrically coupled with the driving transistor; a storage capacitor configured to store a display data voltage from data input; and a threshold capacitor configured to store the threshold voltage; a first transistor; a second transistor; a third transistor.

Wherein: the light-emitting element comprises an organic light-emitting diode (OLED); a gate electrode of the first transistor is coupled with a light emission control line; a first electrode of the first transistor is coupled with a high-level power supply terminal; a second electrode of the first transistor is coupled with a first electrode of the second transistor and a first end of the driving transistor; a second end of the driving transistor is coupled with an anode of the OLED; and a cathode of the OLED is coupled with a low-level ground terminal.

A first scan line can be provided for the pixel driving circuit and is coupled with a gate electrode of the second transistor and a gate electrode of the third transistor. A signal terminal of a signal input circuit is electrically coupled with a second electrode of the second transistor, the first end of the storage capacitor, and the first end of the threshold capacitor. The second end of the threshold capacitor is coupled with a first electrode of the third transistor; and a second electrode of the third transistor is coupled with the cathode of the OLED.

The cathode of the OLED and the second electrode of the third transistor are both coupled with the low-level ground terminal.

The signal input circuit further comprises a fourth transistor, wherein: a gate electrode of the fourth transistor is coupled with a second scan line; a first electrode of the fourth transistor is coupled with a data line; and a second electrode of the fourth transistor is the signal terminal of the signal input circuit.

In another aspect, a pixel driving circuit is provided, including: a driving transistor having a threshold voltage; a light-emitting element electrically coupled with the driving transistor; a storage capacitor configured to store a display data voltage from data input; and a threshold capacitor configured to store the threshold voltage; a first transistor; a second transistor; and a third transistor.

Wherein: the light-emitting element comprises an organic light-emitting diode (OLED); a gate electrode of the first transistor is coupled with a light emission control line; a first electrode of the first transistor is coupled with a high-level power supply terminal; a second electrode of the first transistor is coupled with a first electrode of the second transistor and a first end of the driving transistor; a second end of the driving transistor is coupled with an anode of the OLED; a cathode of the OLED is coupled with a low-level ground terminal.

The third transistor has a first end coupled with the threshold capacitor, and a second end coupled with the cathode of the OLED. The cathode of the OLED is also coupled with a low-level ground terminal.

A first scan line can be provided for the pixel driving circuit and is coupled with a gate electrode of the second transistor and a gate electrode of the third transistor. A signal terminal of a signal input circuit is electrically coupled with a second electrode of the second transistor, the first end of the storage capacitor, and the first end of the threshold capacitor. The second end of the threshold capacitor is coupled with a first electrode of the third transistor; and a second electrode of the third transistor is coupled with the cathode of the OLED.

The cathode of the OLED and the second electrode of the third transistor are both coupled with the low-level ground terminal.

The signal input circuit further comprises a fourth transistor, wherein: a gate electrode of the fourth transistor is coupled with a second scan line; a first electrode of the fourth transistor is coupled with a data line; and a second electrode of the fourth transistor is the signal terminal of the signal input circuit.

The pixel driving circuit further includes a fifth transistor, wherein a first electrode of the fifth transistor is coupled with the anode of the LED and the second end of the driving transistor, and a second electrode of the fifth transistor is coupled with the second electrode of the third transistor and the cathode of the OLED.

Other embodiments, implementations, and advantages may become apparent in view of the following descriptions and the attached drawings.

### BRIEF DESCRIPTION OF DRAWINGS

To more clearly illustrate the embodiments of the disclosure, the following is a brief description of the drawings, which are for illustrative purpose only. For those of ordinary skills in the art, other drawings of other embodiments can become apparent based on these drawings.

FIG. 1 is a schematic diagram of a pixel driving circuit according to a first embodiment of the disclosure;

FIG. 2 is a signal sequence diagram of the driving method in the display apparatus according to an embodiment of the disclosure;

FIG. 3 is an equivalent circuit diagram of the pixel driving circuit at a reset stage;

FIG. 4 is an equivalent circuit diagram of the pixel driving circuit at a threshold compensation stage;

FIG. 5 is an equivalent circuit diagram of the pixel driving circuit at a display data writing stage;

FIG. 6 is an equivalent circuit diagram of the pixel driving circuit at a display stage;

FIG. 7 is an equivalent circuit diagram of the pixel driving circuit at a buffer stage;

FIG. 8 is a schematic diagram of a pixel driving circuit according to a second embodiment of the disclosure; and

FIG. 9 is a schematic diagram of a pixel driving circuit comprising a fifth transistor.

### DETAILED DESCRIPTION

In the following, with reference to the drawings of various embodiments disclosed herein, the technical solutions of the embodiments of the disclosure will be described in a clear and fully understandable way. It is obvious that the described embodiments are merely a portion but not all of the embodiments of the disclosure. Based on the described embodiments of the disclosure, those ordinarily skilled in the art can obtain other embodiment(s), which come(s) within the scope sought for protection by the disclosure.

In an aspect, a pixel driving circuit is provided including: a driving transistor having a threshold voltage; a light-emitting element electrically coupled with a first end of the driving transistor; a storage capacitor configured to store the display data voltage; and a threshold capacitor configured to store the threshold voltage.

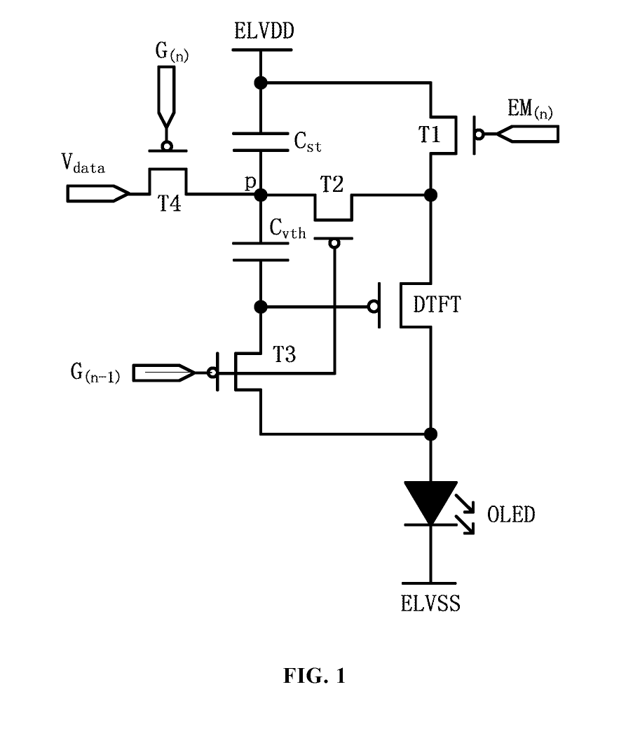

In an example as shown in FIGS. 1-7, the pixel driving circuit includes a first transistor T1, a second transistor T2, a third transistor T3, a light-emitting element such as an OLED, a driving thin-film transistor (DTFT), a storage capacitor Cₛₜ, a threshold capacitor C_{Vth}, and a signal input circuit configured to provide a display data voltage V_{data}.

The pixel driving circuit can be one of a plurality of pixel driving circuits, which together with a plurality of corresponding light-emitting elements form an array to display images on the display apparatus. The array also includes a plurality of scan lines G₁, G₂, . . . , G₍ₙ₋₁₎, G₍ₙ₎, . . . , a plurality of data lines, and a plurality of light emission control lines EM₍₁₎, EM₍₂₎, . . . , EM₍ₙ₎, . . . .

The driving transistor DTFT has a threshold voltage. The light-emitting element can be driven by the driving transistor with the display data voltage V_{data}. The storage capacitor Cₛₜ can be configured to store the display data voltage V_{data}. The threshold capacitor C_{Vth} can be configured to store the threshold voltage.

According to some embodiments disclosed herein, the pixel driving circuit is configured to compensate for a variation in the threshold voltage based on the threshold voltage stored in the threshold capacitor prior to the display data voltage being written to the storage capacitor. As such, a luminance uniformity among the array of light-emitting elements can be improved. For example, the pixel driving circuit can be configured to compensate for a variation in the threshold voltage by generating a driving current for the light-emitting element independent of the threshold voltage.

In some embodiments, the threshold capacitor C_{Vth} can be configured to receive the threshold voltage through the driving transistor DTFT, for example, by effectively shorting a gate electrode and a drain electrode of the driving transistor DTFT.

In some embodiments, the threshold capacitor C_{Vth} can be configured to receive the threshold voltage through a diode configuration of the driving transistor DTFT.

In some embodiments, a light emission control line EM₍ₙ₎ is coupled with a gate electrode of the first transistor T1; a first electrode of the first transistor T1 is coupled with a high-level power supply terminal; a second electrode of the first transistor T1 is coupled with a first electrode of the second transistor T2 and a first end of the driving transistor DTFT; a second end of the driving transistor DTFT is coupled with an anode of the OLED; a cathode of the OLED is coupled with a low-level ground terminal (ELVSS).

A first scan line G₍ₙ₋₁₎ is coupled with a gate electrode of the second transistor T2 and a gate electrode of the third transistor T3.

A signal terminal of the signal input circuit is coupled with the second electrode of the second transistor T2, a first end of the storage capacitor Cₛₜ, and a first end of the threshold capacitor C_{Vth}.

A second end of the storage capacitor Cₛₜ is coupled with the high-level power supply terminal (ELVDD).

A second end of the threshold capacitor C_{Vth} is coupled with a first electrode of the third transistor T3 and the gate electrode of the driving transistor DTFT. A second electrode of the third transistor T3 is coupled with the OLED.

In the first embodiment as illustrated in FIG. 1, the second electrode of the third transistor T3 is coupled with an anode of the OLED.

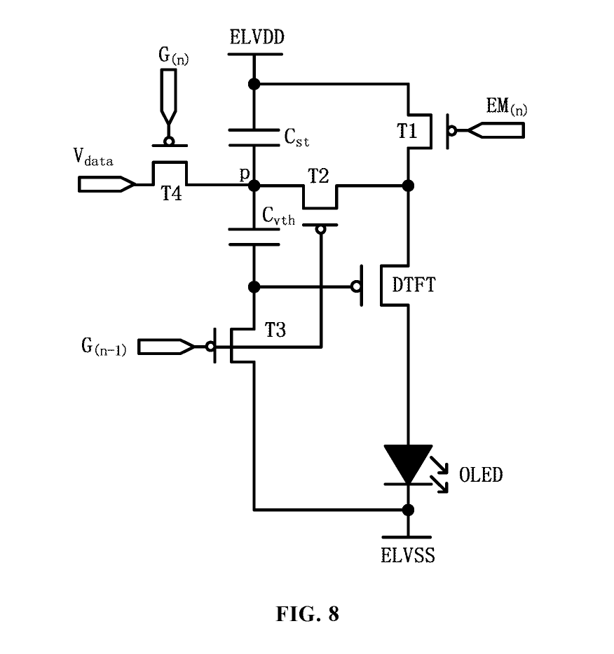

In a second embodiment as illustrated in FIG. 8 and described in more detail below, the second electrode of the third transistor T3 can be coupled with the cathode of the OLED.

The pixel driving circuit according to the second embodiment therefore includes: a driving transistor DTFT having a threshold voltage Vth; a light-emitting element electrically coupled with the driving transistor DTFT; a storage capacitor Cₛₜ configured to store a display data voltage V_{data} from data input; and a threshold capacitor C_{Vth} configured to store the threshold voltage Vth; a first transistor T1; a second transistor T2; a third transistor T3.

In some embodiments, the light-emitting element can comprise an organic light-emitting diode (OLED). A gate electrode of the first transistor T1 is coupled with a light emission control line EM₍ₙ₎; a first electrode of the first transistor T1 is coupled with a high-level power supply terminal ELVDD; a second electrode of the first transistor T1 is coupled with a first electrode of the second transistor T2 and a first end of the driving transistor DTFT; a second end of the driving transistor DTFT is coupled with an anode of the OLED; and a cathode of the OLED is coupled with a low-level ground terminal ELVSS.

A first scan line G₍ₙ₋₁₎ can be provided for the pixel driving circuit and is coupled with a gate electrode of the second transistor T2 and a gate electrode of the third transistor T3. A signal terminal of a signal input circuit is electrically coupled with a second electrode of the second transistor T2, the first end of the storage capacitor Cₛₜ, and the first end of the threshold capacitor C_{Vth}. The second end of the threshold capacitor C_{Vth} is coupled with a first electrode of the third transistor T3; and a second electrode of the third transistor T3 is coupled with the cathode of the OLED.

The cathode of the OLED and the second electrode of the third transistor are both coupled with the low-level ground terminal ELVSS.

The signal input circuit further comprises a fourth transistor T4, wherein: a gate electrode of the fourth transistor T4 is coupled with a second scan line G₍ₙ₎; a first electrode of the fourth transistor T4 is coupled with a data line providing the display data voltage V_{data}; and a second electrode of the fourth transistor T4 is the signal terminal of the signal input circuit.

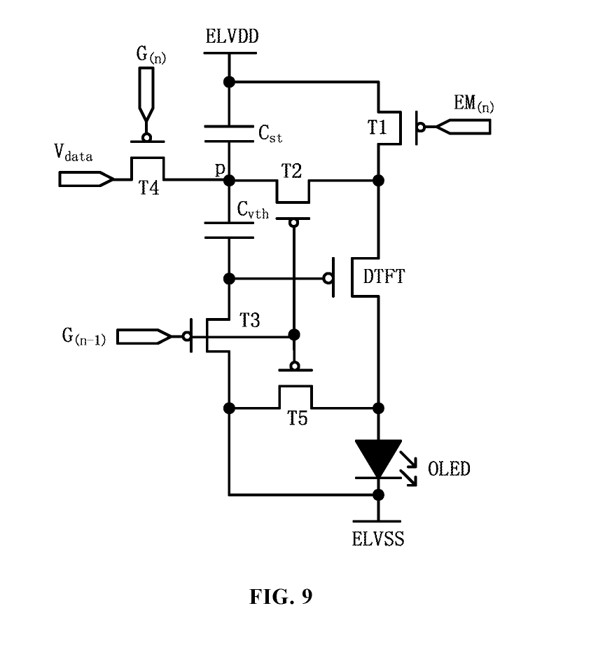

In a third embodiment as illustrated in FIG. 9 and described in more detail below, the second electrode of the third transistor T3 is coupled with the cathode of the OLED, and the pixel driving circuit further includes a fifth transistor T5 having a first electrode coupled with the anode of the OLED and a second electrode coupled with the cathode of the OLED.

The pixel driving circuit according to the third embodiment therefore comprises: a driving transistor DTFT having a threshold voltage Vth; a light-emitting element electrically coupled with the driving transistor DTFT; a storage capacitor Cₛₜ configured to store a display data voltage V_{data} from data input; and a threshold capacitor C_{Vth} configured to store the threshold voltage Vth; a first transistor T1; a second transistor T2; and a third transistor T3.

In some embodiments, the light-emitting element can comprise an organic light-emitting diode (OLED); a gate electrode of the first transistor T1 is coupled with a light emission control line EM₍ₙ₎; a first electrode of the first transistor T1 is coupled with a high-level power supply terminal ELVDD; a second electrode of the first transistor T1 is coupled with a first electrode of the second transistor T2 and a first end of the driving transistor DTFT; a second end of the driving transistor DTFT is coupled with an anode of the OLED; and a cathode of the OLED is coupled with a low-level ground terminal ELVSS.

The third transistor T3 has a first electrode coupled with the threshold capacitor C_{Vth}, and a second electrode coupled with the cathode of the OLED. The cathode of the OLED is also coupled with the low-level ground terminal ELVSS.

A first scan line G₍ₙ₋₁₎ can be provided for the pixel driving circuit. The first scan line G₍ₙ₋₁₎ can be coupled with a gate electrode of the second transistor T2 and a gate electrode of the third transistor T3. A signal terminal of a signal input circuit is electrically coupled with a second electrode of the second transistor T2, the first end of the storage capacitor Cₛₜ, and the first end of the threshold capacitor C_{Vth}. The second end of the threshold capacitor C_{Vth} is coupled with a first electrode of the third transistor T3; and a second electrode of the third transistor T3 is coupled with the cathode of the OLED.

The cathode of the OLED and the second electrode of the third transistor T3 are both coupled with the low-level ground terminal.

The signal input circuit further comprises a fourth transistor, wherein: a gate electrode of the fourth transistor is coupled with a second scan line; a first electrode of the fourth transistor is coupled with a data line; and a second electrode of the fourth transistor is the signal terminal of the signal input circuit.

The pixel driving circuit further includes a fifth transistor T5, wherein a first electrode of the fifth transistor T5 is coupled with the anode of the OLED and the second end of the driving transistor DTFT, and a second electrode of the fifth transistor T5 is coupled with the second electrode of the third transistor and the cathode of the OLED.

A working process of the pixel driving circuit according to the first embodiment is described in detail below with reference to FIGS. 1-6.

To better illustrate the working process of the pixel driving circuit, the connection point where the signal terminal of the signal input circuit, the second electrode of the second transistor T2, the first end of the storage capacitor Cₛₜ, and the first end of the threshold capacitor C_{Vth} all meet is defined as P. The display data voltage is defined as V_{data}, the threshold voltage of the driving transistor DTFT is defined as Vₜₕ, and the voltage between the gate electrode and the second electrode of the driving transistor DTFT is defined as V_{DTFT}.

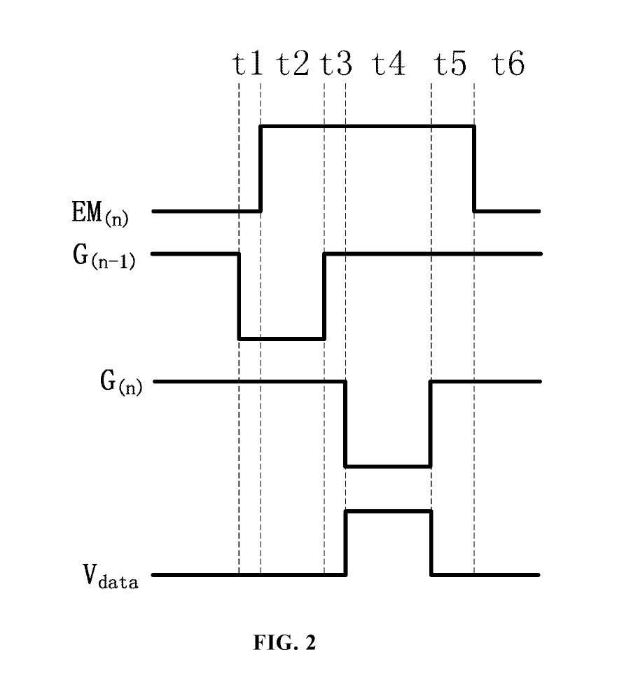

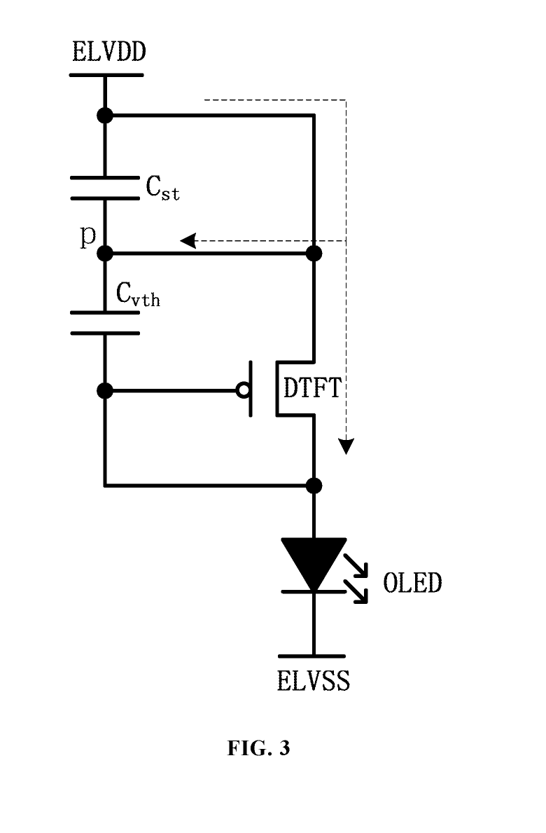

During an operation, as shown in the time period t1 in FIG. 2, and with reference to FIG. 3, the signal input circuit stops providing the display data voltage V_{data}, the light emission control line EM₍ₙ₎ turns on the first transistor T1, and the first scan line G₍ₙ₋₁₎ turns on the second transistor T2 and the third transistor T3.

By turning on both the first transistor T1 and the second transistor T2, the storage capacitor Cₛₜ is shorted at both ends and thus is reset, and the high-level output terminal of the power supply charges the threshold capacitor C_{Vth}.

The voltage between the storage capacitor Cₛₜ and the threshold capacitor C_{Vth} is the voltage output ELVDD by the high-level power supply output terminal, which also means that the potential at the point P is the high-level power supply voltage ELVDD.

By turning on the third transistor T3, the driving transistor DTFT is saturated and generates a driving current. In addition, the voltage across the threshold capacitor C_{Vth} is reset.

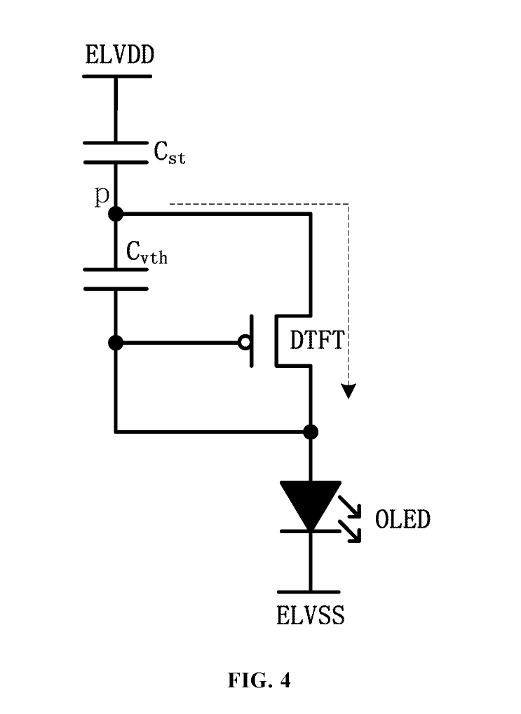

In the time period t2 illustrated in FIG. 2, and with reference to FIG. 4, the signal input circuit stops providing the display data voltage V_{data}, the light emission control line EM₍ₙ₎ turns off the first transistor T1, the first scan line G₍ₙ₋₁₎ turns on the second transistor T2 and the third transistor T3, and the voltage between the storage capacitor Cₛₜ and the threshold capacitor C_{Vth} causes the voltage across the threshold capacitor C_{Vth} to be greater than the threshold voltage Vₜₕ of the driving transistor DTFT, resulting in the driving transistor DTFT to be saturated and generate a driving current.

The voltage across the threshold capacitor C_{Vth} can decrease until reaching the threshold voltage Vth of the driving transistor DTFT, and the driving transistor DTFT cuts off, while the threshold voltage Vₜₕ can be preserved in the threshold capacitor C_{Vth}.

For example, in the process that the driving transistor DTFT generates a driving current, the potential at point P can be continuously consumed and decreasing. When the potential difference between the storage capacitor Cₛₜ and the threshold capacitor C_{Vth} causes the voltage across the threshold capacitor C_{Vth} to be equal to the threshold voltage Vₜₕ, the driving transistor DTFT cuts off, and the voltage across the threshold capacitor C_{Vth} equals the threshold voltage Vₜₕ of the driving transistor DTFT.

Therefore, the threshold capacitor can obtain the threshold voltage based on a cut-off state of the driving transistor, by discharging the first end of the threshold capacitor, until the driving transistor DTFT cuts off.

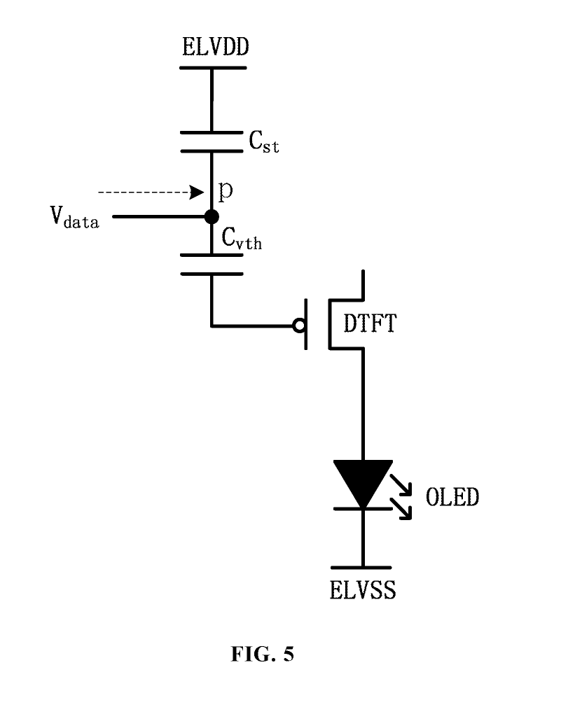

In the time period t4 illustrated in FIG. 2, and with reference to FIG. 5, the light emission control line EM₍ₙ₎ turns off the first transistor T1, the first scan line G₍ₙ₋₁₎ turns off both the second transistor T2 and the third transistor T3; the signal input circuit provides the display data voltage V_{data} and charges the storage capacitor Cₛₜ, causing the potential at point P to be equal to the display data voltage V_{data}, and resulting in the voltage across the storage capacitor Cₛₜ to be equal to the difference between the power supply voltage ELVDD and the display data voltage V_{data}.

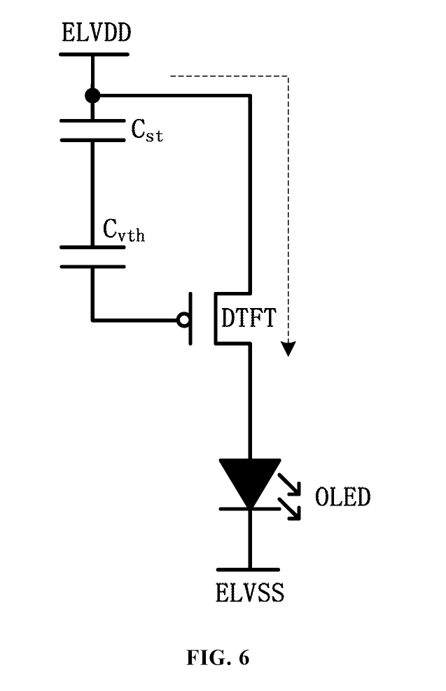

In the time period t6 illustrated in FIG. 2, and with reference to FIG. 6, the signal input circuit stops providing the display data voltage V_{data}, the first scan line G₍ₙ₋₁₎ turns off both the second transistor T2 and the third transistor T3, the light emission control line EM₍ₙ₎ turns on the first transistor T1.

After the first transistor T1 is turned on, the voltage between the gate electrode and the source electrode (e.g., the first electrode) of the driving transistor DTFT V_{DTFT} equals the sum of the voltage across the storage capacitor Cₛₜ and the voltage across the threshold capacitor C_{Vth}; the voltage between the gate electrode and the source electrode of the driving transistor DTFT controls the driving transistor DTFT to generate a driving current to drive the OLED to emit light.

In the pixel driving circuit as described above, by coupling with the gate electrode of the first transistor T1, the light emission control line EM₍ₙ₎ turns on and/or off the first transistor T1; by respective coupling with the gate electrode of the second transistor T2 and the gate electrode of the third transistor T3, the first scan line G₍ₙ₋₁₎ turns on and/or off the second transistor T2 and the third transistor T3.

As such, if the signal input circuit provides the display data voltage V_{data}, the voltage across the storage capacitor Cₛₜ is equal to the difference between the power supply voltage ELVDD and the display data voltage V_{data}, the voltage across the threshold capacitor C_{Vth} is equal to the threshold voltage Vₜₕ of the driving transistor DTFT, and the voltage between the gate electrode and the first electrode of the driving transistor DTFT V_{DTFT} is:

V_{DTFT}=ELVDD−V_{data}+|Vₜₕ|. (I)

In addition, the power supply voltage ELVDD causes the driving transistor DTFT to work in saturation and generate a driving current I_{OLED};

I_{OLED}=k(V_{DTFT}−|Vₜₕ|)². (II)

Combining Formula (I) with Formula (II) results in:

I_{OLED}=k(ELVDD−V_{data}+|Vₜₕ|−|Vₜₕ|)²=k(ELVDD−V_{data})², (III)

wherein k is a constant.

Based on the above formulas, the driving current I_{oled} correlates with the power supply voltage ELVDD and the display data voltage V_{data}, but not with the threshold voltage Vₜₕ. Accordingly, if a same data voltage is applied to a plurality of driving transistors DTFT having different threshold voltages Vₜₕ, the driving currents generated by these driving transistors DTFT while at saturation are the same, such that the corresponding OLEDs driven by their respective driving transistors DTFT can emit light of a same luminescence.

Therefore, the problem of uneven luminescence in OLED display devices resulting from the driving transistors DTFT having different threshold voltages Vₜₕ can be avoided or alleviated.

It can be noted that, depending on the different types of the transistors, the threshold voltage Vₜₕ of the driving transistor TFT can be positive or negative. As such, |Vₜₕ| is used to represent the threshold voltage Vₜₕ in formulas (I)-(III).

In some embodiments, the signal input circuit as described above further comprises a fourth transistor T4 as illustrated in FIG. 1. The second scan line G₍ₙ₎ is coupled with the gate electrode of the fourth transistor T4, the display data voltage V_{data} is coupled with a first electrode of the fourth transistor T4; a second electrode of the fourth transistor T4 is coupled with the second electrode of the second transistor T2; and the second electrode of the fourth transistor T4 is the signal output terminal of the signal input circuit.

In a display data writing stage, the second scan line G₍ₙ₎ turns on the fourth transistor T4, causing the display data voltage V_{data} to be output to point P via the fourth transistor T4. After the display data writing stage is completed, the potential at point P is the display data voltage V_{data}, and the voltage across the storage capacitor Cₛₜ is the difference between the high-level power supply voltage ELVDD and the display data voltage V_{data}.

It should be noted that in the above embodiment, the first scan line G₍ₙ₋₁₎ corresponds to the output of the scanning signal for the last line, the second scan line G₍ₙ₎ corresponds to the output of the scanning signal for the present line, and the light emission control line EM₍ₙ₎ corresponds to the output of the light emission control signal for the present line.

The pixel driving circuit as described above can have different embodiments. In the following, three example embodiments and their respective effects are described.

In the first embodiment, as shown in FIG. 1, the anode of OLED is coupled with the second electrode of the third transistor T3. In the reset stage and the threshold compensation stage, the third transistor T3 is in the ON state, and the gate electrode and the second electrode of the driving transistor DTFT are coupled, allowing the driving transistor DTFT to function as a conventional diode that has the forward conduction characteristics.

This embodiment can ensure that if the voltage between the gate electrode and the first electrode of the driving transistor DTFT, V_{DTFT}, exceeds the threshold voltage Vₜₕ, the driving transistor DTFT remains to have a good conduction, allowing smooth discharge at point P, thereby realizing that the first and second ends of the threshold capacitor C_{Vth} obtain the threshold voltage Vₜₕ.

In the second embodiment, as shown in FIG. 8, the cathode of OLED is coupled with the second electrode of the third transistor T3. In the reset stage and the threshold compensation stage, the third transistor T3 is in the ON state; because OLED is coupled between the gate electrode and the second electrode of the driving transistor DTFT, the potential at the gate electrode of the driving transistor DTFT is lower than the potential at the first electrode of the driving transistor DTFT. This approach allows a good conduction for the driving transistor DTFT, further allowing smooth discharge at point P and a faster process of obtaining the threshold voltage Vₜₕ by the threshold capacitor C_{Vth} at its both ends.

It can be noted that in the above two embodiments, the third transistor T3 is in the OFF state in both the display data writing stage and the display stage. As such, the gate electrode and the second electrode of the driving transistor DTFT are not coupled, and the two embodiments have a same working principle.

In the third embodiment, as shown in FIG. 9, if the above-mentioned second embodiment of a pixel driving circuit is applied to drive the light-emitting diode, the pixel driving circuit can further include a fifth transistor T5. The first scan line G₍ₙ₋₁₎ is coupled with the gate electrode of the fifth transistor T5, the first electrode of the fifth transistor T5 is coupled with the anode of the OLED, and the second electrode of the fifth transistor T5 is coupled with the cathode of the OLED.

In some embodiments, the fifth transistor T5 can be configured to short the anode and the cathode of the light-emitting element to thereby reset the light-emitting element. By reducing un-recombined carriers in the light-emitting element during the reset, the lifetime of the light-emitting element can be improved.

For example, in the reset stage and the threshold compensation stage, the first scan line G₍ₙ₋₁₎ turns on the fifth transistor T5. After the fifth transistor T5 is turned on, the anode and cathode of the OLED is shorted. Because the OLED achieves light emission through recombination of carriers in the organic light-emitting material, and in this process, not all carriers are able to be completely recombined, resulting in part of the carriers remaining on the light emission interface of the organic light-emitting material.

By shorting the anode and cathode of the OLED, it is possible to eliminate the carries left un-recombined at the light emission interface of the organic light-emitting material in the OLED, which eases the issue of aging of the organic light-emitting materials. In the display data writing stage and the display stage, the first scan line G₍ₙ₋₁₎ turns off the fifth transistor T5, realizing the normal driving of OLED by the pixel driving circuit.

It can be noted that in the above embodiments, the first transistor T1, the second transistor T2, the third transistor T3, the fourth transistor T4 and the fifth transistor T5 can be P-channel transistors, or other elements realizing controllable switches.

In some other embodiments, N-channel transistors may be adopted with appropriate circuit designs. In some embodiments, in the same pixel driving circuit, individual transistors can be of a same type, or different types. Each transistor can be modulated by adjusting the sequential level in accordance with its own threshold voltage Vₜₕ.

Based on the working principle of the pixel driving circuit described above, it is possible to readily implement circuits having other devices with functions of controllable switches to replace the pixel driving circuit as disclosed in the above embodiments. Regardless of which type of elements to be applied in the driving circuit, so long as they apply the basic principles of the pixel driving circuit as provided by the disclosure without substantial changes, they shall be covered in the scope of this disclosure.

If the first transistor T1, the second transistor T2, the third transistor T3, the fourth transistor T4, and the fifth transistor T5 are all P-channel transistors, the corresponding voltages for driving to turn on the first transistor T1, the second transistor T2, the third transistor T3, the fourth transistor T4, and the fifth transistor T5 are all low-level voltages, the first electrodes of the first transistor T1, the second transistor T2, the third transistor T3, the fourth transistor T4 and the fifth transistor T5 are all source electrodes, and the second electrodes of T1-T5 are all drain electrodes.

The present disclosure also provides a display apparatus, which comprises a plurality of pixel driving circuits as described above and a plurality of corresponding light-emitting elements forming an array to display images on the display apparatus. The array also includes a plurality of scan lines G₁, G₂, . . . , G₍ₙ₋₁₎, G₍ₙ₎, . . . , a plurality of data lines, and a plurality of light emission control lines EM₍₁₎, EM₍₂₎, . . . , EM₍ₙ₎, configured to provide control signals to the driving circuits. In the display apparatus with the above mentioned pixel driving circuit for driving a plurality of OLEDs to emit light, the driving current for driving the OLEDs is not correlated with the threshold voltage Vₜₕ of the driving transistor DTFT.

As such, if a same display data voltage V_{data} is provided to the various driving transistors DTFT having different threshold voltage Vₜₕ, driving currents generated by the various driving transistors DTFT at saturation are equal, resulting in a same luminescence of the various OLEDs driving respectively by the various driving transistors DTFT, and effectively avoiding the issue of uneven luminescence of an OLED apparatus resulting from different threshold voltages Vₜₕ among various different driving transistors DTFT.

In an aspect, a method is provided for driving a display apparatus. The method can include the following stages.

In the reset stage, shown as the time period t1 of FIG. 2, and with reference to FIG. 3, the signal input circuit stops providing the display data voltage V_{data}, the light emission control line EM₍ₙ₎ turns on the first transistor T1, the first scan line G₍ₙ₋₁₎ turns on both the second transistor T2 and the third transistor T3; after the third transistor T3 is turned on, the driving transistor DTFT is saturated and produces a driving current; the high-level power supply terminal charges the threshold capacitor C_{Vth}, causing the potential between the threshold capacitor C_{Vth} and the storage capacitor Cₛₜ to be equal to the power supply voltage ELVDD output by the high-level power supply terminal, and the voltage across the storage capacitor Cₛₜ and the voltage across the threshold capacitor C_{Vth} are reset.

In the threshold compensation stage, shown as the time period t2 of FIG. 2, and with reference to FIG. 4, the signal input circuit stops providing the display data voltage V_{data}, the light emission control line EM₍ₙ₎ turns off the first transistor T1, and the first scan line G₍ₙ₋₁₎ turns on both the second transistor T2 and the third transistor T3.

If the potential between the storage capacitor Cₛₜ and threshold capacitor C_{Vth} causes the voltage across the threshold capacitor C_{Vth} to be greater than the threshold voltage Vₜₕ of the driving transistor DTFT, the driving transistor DTFT is saturated and generates a driving current; an if the potential between the storage capacitor Cₛₜ and threshold capacitor C_{Vth} causes the voltage across the threshold capacitor C_{Vth} to be equal to the threshold voltage Vₜₕ of the driving transistor DTFT, the driving transistor DTFT is turned off.

In the display data writing stage, shown as the time period t4 of FIG. 2, and with reference to FIG. 5, the light emission control line EM₍ₙ₎ turns off the first transistor T1, the first scan line G₍ₙ₋₁₎ turns off both the second transistor T2 and the third transistor T3; and the signal input circuit provides the display data voltage V_{data}, causing the signal input circuit to charge the storage capacitor Cₛₜ;

In addition, because the third transistor T3 is turned off, the end of the threshold capacitor C_{Vth} coupled with the gate electrode of the driving transistor DTFT is at a floating state. As such, during the display data writing stage, the voltage across the threshold capacitor C_{Vth} is not affected.

In the display stage, shown as the time period t6 of FIG. 2, and with reference to FIG. 6, the signal input circuit stops providing the display data voltage V_{data}, the first scan line G₍ₙ₋₁₎ turns off both the second transistor T2 and the third transistor T3, the light emission control line EM₍ₙ₎ turns on the first transistor T1, and after the first transistor T1 is turned on, the driving transistor DTFT generates a driving current to drive the OLED to emit light.

The various embodiments in the disclosure are described in a progressive way. Same or similar portions or steps among the various embodiments can be referenced to each other, and the portions highlighted in description of each individual embodiment are those differentiating from other embodiments. In particular, for embodiments in the method described above, because they are similar to the embodiments of the product (e.g., the pixel driving circuits and the display apparatus), they are only described in a simplified manner, and the relevant description can be referenced to the description of the product.

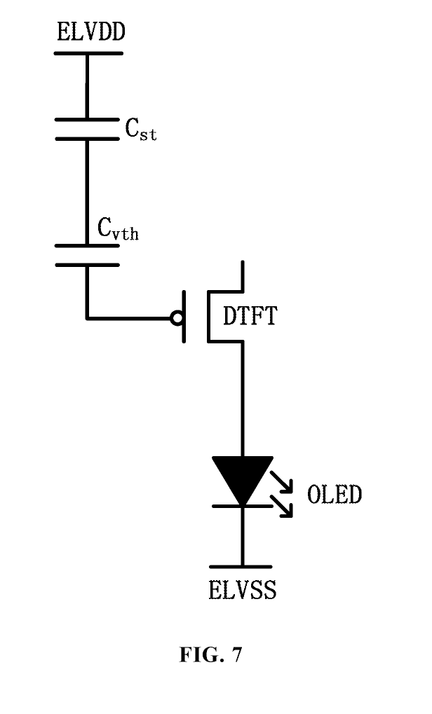

As shown in FIG. 7, at a time period between the threshold compensation stage and the display data writing stage, after the voltage across the threshold capacitor C_{Vth} equals the threshold voltage Vₜₕ of the driving transistor DTFT and before the signal input circuit provides the display data voltage V_{data}, the first scan line G₍ₙ₋₁₎ can be used to turn off both the second transistor T2 and the third transistor T3 in a first buffer stage between the threshold compensation stage and the display data writing stage, which can avoid or reduce the generation of noises by a plurality of control signals being simultaneously switched on or off, e.g., simultaneous hopping of the light emission control line EM₍ₙ₎, the first scan line G₍ₙ₋₁₎ and the second scan line G₍ₙ₎.

Furthermore, at a time period between the display data writing stage and the display stage, after the signal input circuit charges the storage capacitor Cₛₜ and before the driving transistor DTFT generates a driving current, the signal input circuit stops providing the display data voltage V_{data} in a second buffer stage between the display data writing stage and the display stage, which can avoid the generation of noises by a plurality of control signals being simultaneously switched on or off, e.g., simultaneous hopping of the light emission control line EM₍ₙ₎, the first scan line G₍ₙ₋₁₎, and the second scan line G₍ₙ₎.

The display apparatus as described above can also include a fifth transistor T5. The way the fifth transistor T5 is coupled with other components and the advantageous effects it produces are described above with reference to the pixel driving circuit.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A pixel driving circuit, comprising:
a driving transistor having a threshold voltage;
a light-emitting element electrically coupled with the driving transistor;
a storage capacitor configured to store a display data voltage from data input; and
a threshold capacitor configured to store the threshold voltage;
wherein the pixel driving circuit is configured to compensate for a variation in the threshold voltage based on the threshold voltage stored in the threshold capacitor prior to the display data voltage being written to the storage capacitor to thereby improve a luminance uniformity of the light-emitting element.

2. The pixel driving circuit of claim 1, wherein the threshold capacitor is configured to obtain the threshold voltage based on a cut-off state of the driving transistor.

3. The pixel driving circuit of claim 2, wherein the storage capacitor has a first end electrically coupled with a first end of the threshold capacitor, and a second end electrically coupled with a high-level power supply terminal.

4. The pixel driving circuit of claim 3, wherein the threshold capacitor has a second end electrically coupled with a gate electrode of the driving transistor, and is configured to obtain the threshold voltage by discharging the first end of the threshold capacitor until the cut-off state of the driving transistor.

5. The pixel driving circuit of claim 4, wherein the pixel driving circuit is configured to compensate for a variation in the threshold voltage by generating a driving current for the light-emitting element independent of the threshold voltage based on the threshold voltage obtained by the threshold capacitor.

6. The pixel driving circuit of claim 1, further comprising:
a first transistor;
a second transistor;
a third transistor; and
wherein:
the light-emitting element comprises an organic light-emitting diode (OLED);
a gate electrode of the first transistor is coupled with a light emission control line;
a first electrode of the first transistor is coupled with a high-level power supply terminal;
a second electrode of the first transistor is coupled with a first electrode of the second transistor and a first end of the driving transistor;
a second end of the driving transistor is coupled with an anode of the OLED; and
a cathode of the OLED is coupled with a low-level ground terminal.

7. The pixel driving circuit of claim 6, wherein:
a first scan line is coupled with a gate electrode of the second transistor and a gate electrode of the third transistor;
a signal terminal of a signal input circuit is electrically coupled with a second electrode of the second transistor, the first end of the storage capacitor, and the first end of the threshold capacitor;
the second end of the threshold capacitor is coupled with a first electrode of the third transistor; and
a second electrode of the third transistor is coupled with one of the anode or the cathode of the OLED.

8. The pixel driving circuit of claim 7, wherein the signal input circuit further comprises a fourth transistor, wherein:
a gate electrode of the fourth transistor is coupled with a second scan line;
a first electrode of the fourth transistor is coupled with a data line; and
a second electrode of the fourth transistor is the signal terminal of the signal input circuit.

9. The pixel driving circuit of claim 8, further comprising a fifth transistor configured to short the anode and the cathode of the OLED to thereby reset the OLED.

10. The pixel driving circuit of claim 9, wherein:
a gate electrode of the fifth transistor is coupled with the first scan line;
a first electrode of the fifth transistor is coupled with the anode of the OLED; and
a second electrode of the fifth transistor is coupled with the cathode of the OLED.

11. The pixel driving circuit of claim 7, wherein:
the second electrode of the third transistor is coupled with the low-level ground terminal.

12. A display apparatus, comprising a plurality of pixel driving circuits, each pixel driving circuit including:
a driving transistor having a threshold voltage;
a light-emitting element electrically coupled with the driving transistor;
a storage capacitor configured to store a display data voltage from data input; and
a threshold capacitor configured to store the threshold voltage;
wherein the pixel driving circuit is configured to compensate for a variation in the threshold voltage based on the threshold voltage stored in the threshold capacitor prior to the display data voltage being written to the storage capacitor to thereby improve a luminance uniformity of the light-emitting element.

13. A method of driving a display apparatus comprising a plurality of pixels each having at least one light-emitting element, the method comprising:
for each pixel, storing a threshold voltage of a driving transistor in a threshold voltage capacitor;
for each pixel, writing a display data voltage to a storage capacitor; and
displaying an image over the plurality of pixels according to the plurality of display data voltages and compensating for a variation in the plurality of threshold voltages based on the stored threshold voltage to thereby improve a luminance uniformity of the displayed image.

14. The method of claim 13, further comprising, prior to the storing the threshold voltage, obtaining the threshold voltage based on a cut-off state of the driving transistor.

15. The method of claim 14, further comprising:
a reset stage including resetting the storage capacitor and the threshold voltage capacitor;
a threshold compensation stage including the obtaining the threshold voltage by discharging the threshold capacitor until the cut-off state of the driving transistor;
a display data writing stage including the writing the display data voltage; and
a display stage including the displaying the image.

16. The method of claim 15, further comprising shorting an anode and a cathode of the light-emitting element to thereby reduce un-recombined carriers in the light-emitting element.

17. The method of claim 16, further comprising a first buffer stage between the threshold compensation stage and the display data writing stage to prevent noise resulting from a plurality of control signals being simultaneously switched on or off.

18. The method of claim 16, further comprising a second buffer stage between the display data writing stage and the display stage to prevent noise resulting from the plurality of control signals being simultaneously switched on or off.

19. The method of claim 15, wherein the obtaining the threshold voltage comprises discharging the threshold voltage capacitor from a high-level power supply voltage until the pixel driving transistor turns off.

20. The method of claim 19, wherein the displaying the image comprises driving the light-emitting element with a saturation current of the pixel driving transistor independent of the threshold voltage of the pixel driving transistor.
